(19) United States
(12) Patent Application Publication
(10) Pub. No.: US 2005/0273827 A1
(43) Pub. Date: Dec. 8, 2005

(54) Set-top box for internet-based distribution of video and other data

(76) Inventors: Shoeb M. Javed, Plano, TX (US); John E. Tuder, Celina, TX (US); Venkatesh Adivi, San Antonio, TX (US)

Correspondence Address: Philip L. Rawls;Vesta Broadband Services, 6510 Abrams Raod, Suite 215, Dallas, TX, 75231, US

(21) Appl. No.: 10/832,623

(22) Filed: Apr. 27, 2004

Related U.S. Application Data
(63) Continuation of application No. 09/656,553, filed on Sep. 6, 2000, now abandoned.
(60) Provisional application No. 60/153,735, filed on Sep. 13, 1999.

(51) Int. Cl. H04N 7/173; H04N 7/16

(52) U.S. Cl. 725/90; 725/134; 725/142; 725/112; 725/113; 725/87

(57) ABSTRACT

A subscriber video player for use in a communication network that communicates with a plurality of video content servers that provide a plurality of video files for download to a subscriber. The subscriber video player comprises: 1) a storage medium for storing selected ones of the plurality of video files downloaded from the plurality of video content servers; 2) a first controller for receiving inputs from a first subscriber using the subscriber video player; and 3) a browser application coupled to the first controller and responsive to the inputs from the first subscriber, the browser application for accessing the video content servers and retrieving therefrom web page data associated with the plurality of video files and displaying the web page data on a display screen coupled to the subscriber video player.

### CROSS-REFERENCE TO RELATED APPLICATIONS

The present invention is related to those disclosed in the following United States Patent Applications:
1. Provisional Ser. No. 60/153,735, filed on Sep. 13, 1999, entitled “SYSTEMS FOR CONTROLLING INTERNET BASED DISTRIBUTION OF VIDEO AND OTHER DATA AND METHODS OF OPERATING THESE SYSTEMS”;
2. Ser. No. 09/547,204, filed on Apr. 12, 2000, entitled “SYSTEMS-AND METHODS FOR CONTROLLING INTERNET-BASED DISTRIBUTION OF VIDEO AND OTHER DATA”;
3. Ser. No. 09/621,839, filed on Jul. 24, 2000, entitled “SYSTEM AND METHOD FOR EXTENDING RENTAL PERIOD OF DOWNLOADED VIDEO.”

The above applications are commonly assigned to the assignee of the present invention. The disclosures of these related patent applications are hereby incorporated by reference into the present disclosure as if fully set forth herein.

### TECHNICAL FIELD OF THE INVENTION

The present invention relates generally to systems and methods for the distribution of video files via a public communications network and, more particularly, to network video player that may be connected to a television set and used to rent and to download video files and other data files distributed via an Internet protocol (IP) network.

### BACKGROUND OF THE INVENTION

Every year millions of consumers rent videos from video rental stores such as BLOCKBUSTER®. Video stores provide videos on video cassette recorder (VCR) tapes and on digital versatile disks (DVDs). One of the attractive features of renting or buying a video is that is offers a person an opportunity to shop for a wide variety of movies, including recent studio releases and older movies that have been out of theaters for a long time. The attractive movie box covers displayed on shelves in a video store serve to remind shoppers of movies they may have missed when the movies were still in theaters. The box covers also introduce shoppers to movies with which they are unfamiliar.

Another attractive feature of renting or buying a video is that it provides a person with the convenience of watching a particular movie when the person wants to watch the movie. Thus, the consumer does not have to wait for the movie to be broadcast again in order to view it. Furthermore, if a person rents or buys a video, he or she does not have to watch commercials and does not have to watch the entire movie in one sitting, but may pause the video at his or her convenience. The conveniences of buying or renting a video are particularly important to a consumer whose infrequent television viewing habits do not just justify the cost of paying for premium movie channels, such as HBO® or SHOWTIME®.

Unfortunately there are numerous inconveniences associated with buying or renting videos from a video store. Every video rental involves the inconvenience of two trips to the video store: one trip to rent the video and one trip to return the video. If the consumer is not able to return the video to the video store by the return deadline, the consumer must pay a daily late fee that frequently is larger than the original daily rental fee. In fact, a significant portion of the revenues of many video stores come from late fees. Many consumers would prefer not to go out in bad weather to rent a video or, more importantly, to return a video.

Therefore, there is a need for automated systems and methods for previewing and renting (or purchasing) videos over a common communication network that a consumer may easily access. In particular, there is a need in the art for systems and methods of distributing video that allow a consumer to access video content from a variety of different video servers in a data network. More particularly, there is a need in the art for an Internet-based video distribution system that allows a consumer to preview and to rent (or purchase) a video online and to download the rented or purchased video to a video player device in the consumer's home or office. Moreover, there is further need for a video distribution system that is capable of extending the rental period of a video that has already been downloaded to a video player device in the consumer's home.

### SUMMARY OF THE INVENTION

The present invention provides advantageous embodiments of an Internet-based video rental, sales, and distribution network that allows subscribers to securely buy, rent, or otherwise acquire stored video files or other data files, including music audio files, using a high-speed connection to the Internet. The present invention also provides a software controller for handling transactions to buy, rent or otherwise acquire the video content over the Internet. However, the present invention is by no means limited to a software controller embodiment, it should be understood that the controller may be implemented in software, hardware, firmware, or some combination of these elements.

The purchased, rented, or otherwise acquired video file or other data file is downloaded to a subscriber's video player and is then available for local viewing on the subscriber's television or other video display device for the duration of the rental period or indefinitely if the video content is purchased outright.

One advantageous embodiment of the proposed exemplary video distribution network includes multiple subscriber video player devices, a video Internet service provider (VISP), and multiple video points-of-presence (VPOPs). A VPOP is an Internet server providing digitally compressed video content for sale, rental or distribution to subscribers. The exemplary VISP is a web portal site that allows subscribers to select video content from a variety of different VPOP servers and allows video content providers (VPOPs) to advertise, rent, sell or otherwise distribute their video content to subscribers. The VISP provides typical e-commerce services like billing, user authentication, security, advertising, and the like. Once a selection is made the video content is then downloaded from the VPOP to the subscriber's video player for local viewing on the subscriber's television set. The subscriber uses a network video player (NVP), which is a device that includes one or more controllers used for browsing the VISP web site and downloading and playing video content on the subscriber's television set. NVP hardware and software may be embedded in a multitude of consumer electronic devices, including the television itself, a VCR, a DVD player, a CD player, a cable television set-top box, a personal computer (PC), and the like. In a preferred embodiment of the present invention, the NVP accesses the Internet by means of a digital subscriber loop (DSL), which is a controller for transmitting high speed data, such as over existing twisted pair copper wire, between the subscriber and the central office of the public switched telephone network (PSTN).

In accordance with one embodiment of the present invention, header data fields are inserted in the video content in the subscriber's video player as well as in the VPOP servers to prevent piracy of the downloaded video content. Special software routines are executed in the subscriber's video player and in the VPOPs to perform the transactions for buying, renting or otherwise acquiring the video content, or other data, over the Internet. The VISP may use commercially available e-commerce software and security packages to handle user authentication and billing, or alternatively, the functionality of such e-commerce software and security packages may be integrated into the VISP.

To address the above-discussed deficiencies of the prior art, it is a primary object of the present invention to provide a subscriber video player for use in a communication network capable of communicating with a plurality of video content servers capable of providing a plurality of video files for download to a subscriber. According to an advantageous embodiment of the present invention, the subscriber video player comprises: 1) a storage medium capable of storing selected ones of the plurality of video files downloaded from the plurality of video content servers; 2) a first controller capable of receiving inputs from a first subscriber using the subscriber video player; and 3) a browser application coupled to the first controller and responsive to the inputs from the first subscriber, the browser application capable of accessing the video content servers and retrieving therefrom web page data associated with the plurality of video files and displaying the web page data on a display screen coupled to the subscriber video player.

According to one embodiment of the present invention, the browser application, in response to a first input from the first subscriber requesting a first selected one of the plurality of video files, retrieves the first selected video file from a first one of the plurality of video content servers and stores the retrieved first selected video file on the storage medium.

According to another embodiment of the present invention, the browser application is capable of displaying on the display screen a plurality of video selection menus associated with the web page data, a first one of the video selection menus containing a first menu option associated with the first selected video file, wherein the browser application is further capable of receiving from the first subscriber a first video selection message selecting the first selected video file for downloading to the subscriber video player.

According to still another embodiment of the present invention, the browser application, in response to receipt of the first video selection message, transmits to the first video content server a video request message comprising a subscriber identifier associated with the subscriber video player, the video request message capable of causing the first video content server to transmit the first selected video file to the subscriber video player when the subscriber video player subsequently transmits the subscriber identifier to the first video content server.

According to yet another embodiment of the present invention, the video request message further comprises a video identifier associated with the first selected video file, wherein the first video content server uses the video identifier to select the first selected video file from the plurality of video files for transmission to the subscriber video player.

According to a further embodiment of the present invention, the subscriber video player further comprises a video processor coupled to the browser application and capable of receiving the web page data from the browser application and displaying the web page data on the display screen.

According to a still further embodiment of the present invention, the first video processor is further capable of receiving an incoming television signal from an external source and displaying the incoming television signal on the display screen.

According to a yet further embodiment of the present invention, the external source is one of an antenna and a cable television system.

Before undertaking the DETAILED DESCRIPTION OF THE INVENTION, it may be advantageous to set forth definitions of certain words and phrases used throughout this patent document: the terms “include” and “comprise” and their derivatives mean inclusion without limitation; the term “or” is inclusive, meaning and/or; the term “associable” and the phrases “associated with” and “associated therewith” and their derivatives thereof may mean to include, be included within, interconnect with, contain, be contained within, connect to or with, coupled to or with, be communicable with, cooperate with, interleave, juxtapose, be proximate to, be bound to or with, have, have a property of, or the like; and the term “controller” means any device, system or part thereof that controls at least one operation. Such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a block diagram of an exemplary automated video distribution system according to one embodiment of the present invention;

FIG. 2 is a more detailed block diagram of selected portions of the exemplary automated video distribution system according to one embodiment of the present invention;

FIG. 3 is a message flow diagram illustrating an exemplary end-to-end video rental or sale transaction between an exemplary network video player (NVP), an exemplary video Internet service provider (VISP) network and an exemplary video point-of-presence (VPOP) network according to one embodiment of the present invention;

FIG. 4 is a message flow diagram illustrating an exemplary process of viewing a video already rented by the subscriber according to one embodiment of the present invention;

FIG. 5 is a message flow diagram illustrating an exemplary process of extending the rental duration for a video already downloaded to an exemplary NVP according to one embodiment of the present invention;

FIG. 6 illustrates an exemplary header that may be attached to video files downloaded to an NVP according to one embodiment of the present invention;

FIG. 7 illustrates an exemplary header that may be attached to video files stored on a VPOP network according to one embodiment of the present invention;

FIG. 8 illustrates an exemplary header that may be attached to records in the VPOP database for each copy of a video rented according to one embodiment of the present invention;

FIG. 9 illustrates an exemplary web page from which a subscriber using the exemplary network video player may select a video to rent or to purchase, according to one embodiment of the present invention;

FIG. 10 illustrates an exemplary web page from which a subscriber may learn additional details concerning a selected video, according to one embodiment of the present invention;

FIG. 11 is a more detailed block diagram of selected portions of the exemplary network video player according to one embodiment of the present invention; and

FIG. 12 is a flow chart illustrating the operation of the exemplary network video player according to one embodiment of the present invention.

### DETAILED DESCRIPTION OF INVENTION

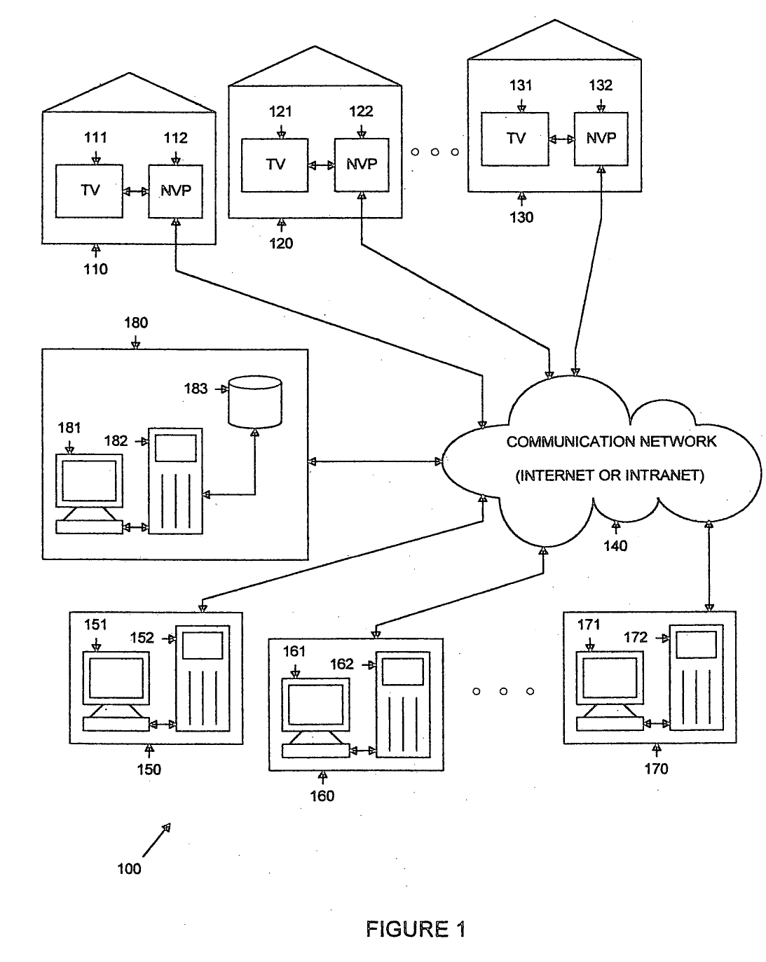

FIGS. 1 through 12, discussed below, and the various embodiments used to describe the principles' of the present invention in this patent document are by way of illustration only and should not be construed in any way to limit the scope of the invention. Those skilled in the art will understand that the principles of the present invention may be implemented in any suitably arranged data network.

FIG. 1 is a block diagram of automated video distribution system 100 according to one embodiment of the present invention. Automated video distribution system 100 comprises a group of “M” subscriber sites (typically homes), including exemplary subscriber sites 110, 120, and 130, and a group of “N” video point-of-presence (VPOP) networks, including exemplary VPOP network 150, VPOP network 160, and VPOP network 170. Automated video distribution system 100 also comprises video Internet service provider (VISP) network 180. The subscriber sites, VPOP networks, and VISP network 180 communicate over common communication network 140, which is an Internet protocol (IP) based network, such as the Internet or one or more privately owned IP-based intranets.

Exemplary subscriber site 110 comprises television set 111 and exemplary network video player (NVP) 112 according to the principles of the present invention. Similarly, exemplary subscriber site 120 comprises television set 121 and exemplary network video player (NVP) 122 and exemplary subscriber site 130 comprises television set 131 and exemplary network video player (NVP) 132. As will be described below in greater detail, subscribers use NVP 112, NVP 122 and NVP 132 to access VISP network 180 in order to rent or purchase videos that are stored on one or more of VPOP network 150, VPOP network 160 and VPOP network 170. One or more of NVP 112, NVP 122 and NVP 132 may be implemented as a stand-alone device, such as a set top box or a personal computer, attached to a corresponding one of television sets 111, 121 and 131. Alternatively, one or more of NVP 112, NVP 122 and NVP 132 may be integrated into a corresponding one of television sets 111, 121 and 131.

Exemplary VPOP network 150 may comprise one or more workstations, collectively represented by workstation 151, and one or more video access servers, collectively represented by VPOP server 152. Similarly, exemplary VPOP network 160 may comprise one or more workstations, collectively represented by workstation 161, and one or more video access servers, collectively represented by video access server 162. Finally, exemplary VPOP network 170 may comprise one or more workstations, collectively represented by workstation 171, and one or more video access servers, collectively represented by video access server 172. As will be explained below in greater detail, each of VPOP networks-150, 160 and 170 allows subscribers previously authenticated and authorized by VISP network 180 to access and download video files.

Finally, VISP network 180 comprises one or more workstations, collectively represented by workstation 181, one or more servers, collectively represented by VISP server 182, and one or more database storage devices, collectively represented by VISP database 183. Among other things, VISP server 182 acts as a broker between a subscriber that wishes to download a selected video and a VPOP that has the selected video file.

It should be understood that the above-described embodiments of subscriber sites 110, 120, and 130, VPOP networks 150, 160, and 170, and VISP network 180 are illustrative only and that other architectures may be employed that do not depart from the spirit and scope of the invention. For example, in some embodiments of the present invention, one or more of NVP 112, NVP 122 and NVP 132, and VPOP networks 150, 160, and 170 may comprise a single desktop personal computer (PC) coupled to the Internet that provides a single subscriber with access to VISP network 180. In some embodiments of the present invention, one or more of NVP 112, NVP 122 and NVP 132 may be a laptop computer that is capable of accessing the Internet (i.e., common communication network 140) via a wireless modem. Similarly, one or more of VPOP networks 150, 160, and 170 may be connected wirelessly to communication network 140, such as by a satellite link.

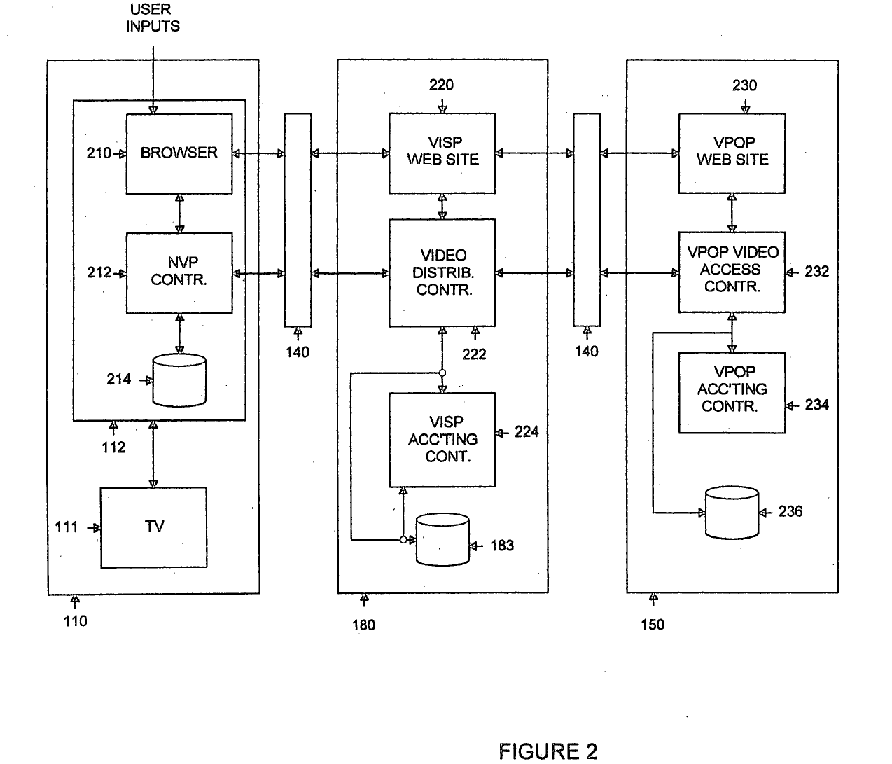

FIG. 2 is a more detailed block diagram of selected portions of automated video distribution system 100 according to one embodiment of the present invention. In particular, FIG. 2 illustrates selected portions of subscriber site 110, VPOP network 150, VISP network 180 and common communication network 140. Network video player (NVP) 110 in subscriber site 110 comprises browser software application 210 (hereafter, simply “browser 210”), NVP controller 212, and NVP storage device 214 (typically a disk drive, which stores downloaded videos. VPOP network 150 comprises VPOP web site software application 230 (hereafter, simply “VPOP web site 230”), VPOP video access controller 232, VPOP accounting controller 234, and VPOP database 236. Finally, VISP network 180 comprises VISP web site software application 220 (hereafter, simply “VISP web site 220”), video distribution controller 222, VISP accounting controller 224, and VISP database 183.

The term “controller” as used with respect to the items in FIG. 2 is broadly defined and may mean any device, system or part thereof that controls at least one operation. Such a device may be implemented in hardware or software, or a combination of hardware and software. Furthermore, the functionality associated with any particular controller may be centralized or distributed, whether locally or remotely. A controller may comprise one or more data processors, and associated input/output devices and memory, that execute one or more application programs and/or an operating system program.

In particular, NVP controller 212 may comprise software applications executed by the central processing unit (CPU) in NVP 112, which may also execute browser 210. Likewise, VPOP video access controller 232 and VPOP accounting controller 234 may comprise software applications executed by the central processing unit (CPU) in VPOP server 152. VPOP server 152 may also execute VPOP web site 230. Finally, video distribution controller 222 VISP accounting controller 224 may comprise software applications executed by the central processing unit (CPU) in VISP server 182. VISP server 182 may also execute VISP web site 220.

When the subscriber of subscriber site 110 first rents or buys a video file via VISP network 180, NVP controller 212, which may work in cooperation with browser 210, gathers initial setup data from the subscriber, such as a personal name, credit card number, address information, and the like, and transfer this information to VISP accounting controller 224. If the subscriber at subscriber site 110 has previously used VISP network 180, a user name and password prompt may be used to quickly identify the subscriber and retrieve previously stored information from VISP database 183. Thus, NVP controller 212 and VISP accounting controller 224 may be used to gather details about particular subscribers that have previously used VISP network 180 and also may be used to gather information from new subscribers that are using VISP network 180 for the first time.

When a subscriber wishes to buy or rent a video, the subscriber browses VISP web site 220, which is capable of accessing VPOP web site 230 and other VPOP web sites in order to retrieve video files and related identification information stored on VPOP database 236. Video distribution controller 222 guides the subscriber through a sequence of web site menus from which the subscriber may select a video. Video distribution controller 222 transfers information related to the selected video to VPOP video access controller 232 that allows the subscriber to subsequently communicate with VPOP video access controller 232 in order to download the selected video via communication network 140. After the subscriber has selected a video to download, NVP controller 212 communicates with VPOP video access controller 232 to actually download the selected video file. Payment for the rented or purchased video and related invoicing information is then transferred from VISP accounting controller 224 to VPOP accounting controller 234.

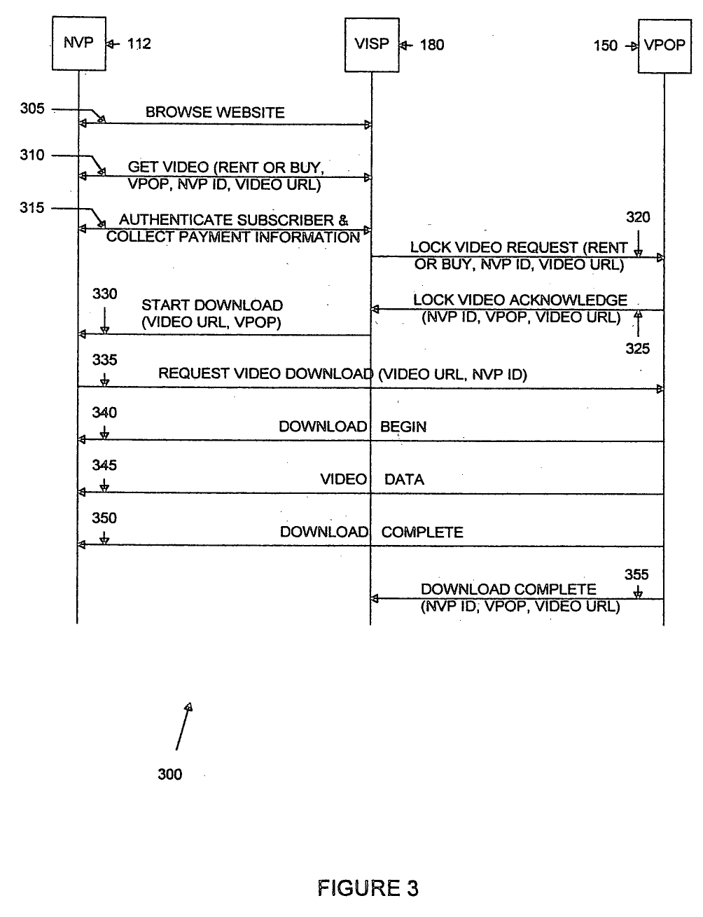

FIG. 3 depicts message flow diagram 300, which illustrates an exemplary end-to-end video rental or sale transaction between NVP 112, VISP network 180 and VPOP network 150 according to one embodiment of the present invention. Initially, a subscriber using NVP 112 changes to the video services channel on television 111. The process of changing to the video services channel initiates an IP connection between NVP 112 and VISP network 180. At this point, VISP web site 220 at VISP network 180 appears on the screen of television 111. The subscriber uses the TV remote control, wireless keyboard or a pointing device, such as a mouse coupled to NVP 112, to browse WISP web site 220 to select the video content that he or she prefers to buy, rent or otherwise acquire. A variety of selection criteria may be used to select the video content. VISP network 180 then displays a list of VPOPs, including VPOP network 150, offering the video content selected by the subscriber. The subscriber then chooses a VPOP from which to buy or rent the video content. The VPOP-selection criteria may be determined by geographical location (quicker downloads), cost of the video content, and any other differentiator, whether based on technological constraints, economic issue, or any other related resource allocation issues, that the VPOPs use to attract and retain customers. The subscriber also chooses whether the video content is to be rented or purchased, and if rented, the duration of the rental (process step 305).

Once the video content and VPOP selection is made, VISP network 180 authenticates the subscriber (possibly using subscriber account number, password, and the like) and collects payment information (credit card, add to cable bill, and the like) (process step 310). VISP network 180 then asks VPOP network 150 to reserve a copy of the video content (Lock Video Request) requested by the subscriber by sending VPOP network 150 the subscriber's unique NVP ID. The NVP ID is a code embedded in NVP 112. VISP network 180 also informs VPOP network 150 whether the video content is to be rented or purchased by the subscriber, and if rented, the rental duration (process step 315).

VPOP network 150 responds by reserving a copy of the video content rented or purchased by the subscriber and sends a positive acknowledgment (Lock Video Acknowledgment) to VISP network 180. VISP network 180 creates a billing record with the subscriber's account information and NVP ID for the video content rented or purchased (process step 320). VISP network 180 then sends a positive acknowledgment to NVP 112 to begin downloading the video content from VPOP network 150 (process step 330).

Next, NVP 112 connects to VPOP network 150 and provides information (Video URL) identifying the movie to be purchased or rented as well as the unique NVP ID of NVP 112 (process step 335). VPOP network 150 verifies that a record exists for the NVP ID and the video content requested by NVP 112. VPOP network 150 then downloads a file containing the requested video content to NVP 112 (process steps 340, 345 and 350). After the download is complete, VPOP network 150 informs VISP network 180 that the download is complete, providing VISP network 180 with the subscriber's NVP ID as well as identifying the video content rented or purchased. VISP network 180 then completes and closes the billing record created for the subscriber using NVP 112 (process step 355).

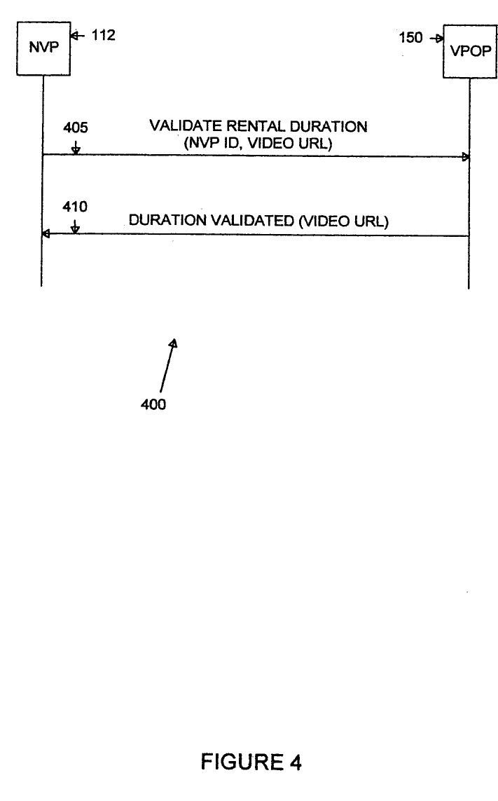

FIG. 4 depicts message flow diagram 400, which illustrates an exemplary process of viewing a video already rented by the subscriber according to one embodiment of the present invention. Initially, the subscriber, using the remote control of television 111 or appointing device coupled to NVP 112, selects and plays the rented video. NVP 112 connects to VPOP network 150 from which the video was rented and requests VPOP network 150 to verify that the rental duration for the video is still current. NVP 112 provides VPOP network 150 the video URL as well as the unique NVP ID of NVP 112 (process step 405). VPOP network 150 locates the rental record for the NVP ID and video URL sent by NVP 112. VPOP network 150 compares the time-stamp on the rental record with the current time to see if the video is within the rental duration paid for by the subscriber. If the video is still within the rental duration paid for by the subscriber, VPOP network 150 sends an acknowledgment to NVP 112 that the video may be viewed by the subscriber (process step 410). NVP 112 then plays the video on television 111.

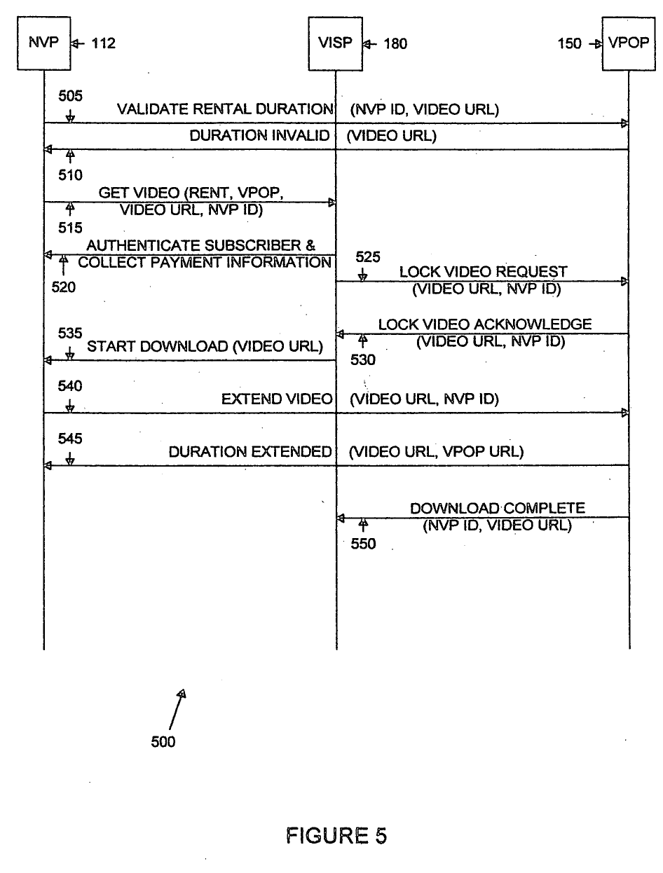

FIG. 5 depicts message flow diagram 500, which illustrates an exemplary process of extending the rental duration for a video already downloaded to NVP 112 according to one embodiment of the present invention. Initially, the subscriber, using the remote control of television 111 or a pointing device coupled to NVP 112, selects and plays the rented video. NVP 112 connects to VPOP network 150 from which the video was rented and requests VPOP network 150 to verify that the rental duration for the video is still current. NVP 112 provides VPOP network 150 the video URL as well as the NVP ID of NVP 112 (process step 505). VPOP network 150 locates the rental record for the NVP ID and video URL sent by NVP 112. VPOP network 150 compares the time-stamp on the rental record with the current time to see if the video is within the rental duration paid for by the subscriber. VPOP network 150 determines that the rental period on the video requested by NVP 112 has expired and sends a negative acknowledgment back to NVP 112 (process step 510).

Next, NVP 112 prompts the subscriber to extend the rental duration and the subscriber elects to extend the rental duration for the video to be viewed. NVP 112 connects to VISP network 180 and sends a rental request providing VISP network 180 with the unique NVP ID of NVP 112, the video URL and VPOP network 150 information (process step 515). VISP network 180 then authenticates the subscriber and collects payment information (process step 520).

Once payment is collected, VISP network 180 requests VPOP network 150 to reserve a copy of the video content requested by the subscriber by sending VPOP network 150 the unique NVP ID of NVP 112. VISP network 180 also informs VPOP network 150 of the rental duration (process step 525). VPOP network 150 responds by reserving a copy of the video content rented by the subscriber and sends a positive acknowledgment to VISP network 180. In response, VISP network 180 creates a billing record with the subscriber's account information and the NVP ID of NVP 112 for the video content rented (process step 530).

VISP network 180 sends a positive acknowledgment to NVP 112 to begin downloading the video content from VPOP network 150 (process step 535). NVP 112 connects to VPOP network 150 and requests that the rental duration for the video be extended, providing VPOP network 150 with the corresponding video URL and the NVP ID of NVP 112 (process step 540). VPOP network 150 verifies that a record exists for the NVP ID of NVP 112 for the video content requested by NVP 112. VPOP network 150 then downloads a new header to NVP 112 with the rental extension information (process step 545). VPOP network 150 informs VISP network 180 that the download is complete, providing VISP network 180 with the NVP ID of NVP 112 as well as the video content rented. VISP network 180 then completes and closes the billing record for the subscriber (process step 550).

To carry out the exemplary transactions described above, each of the network components implementing the video network may carry out various processes that are described below.

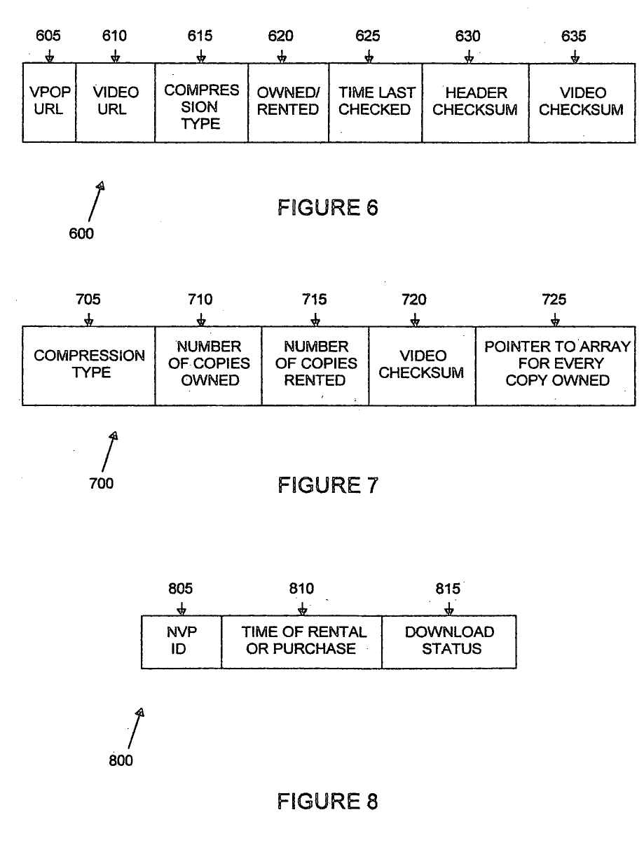

FIG. 6 illustrates exemplary header 600, which may be attached to video files downloaded to NVP 112 according to one embodiment of the present invention. Exemplary header 600 comprises seven data fields. Field 605 in header 600 contains the URL of the VPOP network (e.g., VPOP network 150) that provides the downloaded video file. The VPOP URL in field 605 allows NVP 112 to determine the source of the downloaded video file. The VPOP URL may subsequently used to validate whether the video is still within the rented duration, as well as to extend the rental duration if requested by the subscriber.

Field 610 in header 600 contains the URL of the selected video. The VIDEO URL allows NVP 112 to uniquely identify the video to VPOP network 150 as well as VISP network 180 during the rental, purchase, viewing, and extension transactions. Field 615 in header 600 contains the Compression Type. The Compression Type data tells NVP 112 what algorithm was used to compress the video content. This information is used by NVP 112 to decompress the stored video for viewing.

Field 620 in header 600 contains a data value indicating whether the video was rented or purchased by the subscriber. The Owned/Rented data value is used by NVP 112 to determine if it is necessary to check the rental period validity before playing the video on television 111. Field 625 in header 600 contains a time stamp of the last time the video was played. The Time Last Checked data value is used by NVP 112 to determine if it is necessary to check with VPOP network 150 for rental period validity before playing the video on television 111.

Field 630 in header 600 contains a checksum value for all of the data in header 600. The Header Checksum value is used by NVP 112 to determine whether the header downloaded from VPOP network 150 during video rental transactions was received without errors. Field 635 in header 600 contains a checksum value for all of the video file, excluding header 600. The Video Checksum value is used by NVP 112 to determine whether the video file downloaded from VPOP network 150 was received without errors.

FIG. 7 illustrates exemplary header 700, which may be attached to video files stored on VPOP network 150 according to one embodiment of the present invention. Exemplary header 700 comprises five data fields. Field 705 in header 700 contains the compression type. The Compression Type data identifies the algorithm used to compress the video content. This information is used to decode the video for viewing on NVP 112. Field 710 in header 700 contains the number of copies of the video owned by VPOP network 150. The Number of Copies Owned value determines how many copies of the video may be rented or sold by VPOP network 150.

Field 715 in header 700 contains the number of copies of the video currently rented from VPOP network 150. The Number of Copies Rented value keeps a real-time record of the number of each video file that have been rented to subscribers. Field 720 in header 700 contains a checksum of the actual video content. The Video Checksum value is used during the video download process to ensure that all of the video content is correctly downloaded from VPOP network 150 to NVP 112. Field 725 in header 700 contains a pointer to an array of records, one for each copy of the video rented from VPOP network 150. The records array keeps track of which NVP rented each video and when the video was rented.

FIG. 8 illustrates exemplary header 800, which may be attached to records in VPOP database 236 for each copy of a video rented according to one embodiment of the present invention. Field 805 in header 800 contains the NVP ID of NVP 112, which belongs to the subscriber that rented the video. Field 810 in header 800 contains the time at which the video was rented by NVP 112. Field 815 in header 800 contains a status value indicating whether or not the video has been downloaded by NVP 112 or if a download is still pending.

VPOP network 150 can receive inputs from NVP 112, VISP network 180 or database updates from the local system administrator. Database updates to VPOP network 150 happen when new videos are added to or deleted from VPOP network 150 or if additional copies of an existing video are purchased. The addition of new videos requires VPOP network 150 to send the database updates to VISP network 180 to ensure that VISP network 180 has current information on all VPOPs carrying the newly added video. The database updates for adding more copies of an existing video are local changes and do not have to be sent to VISP network 180.

When VPOP network 150 receives a lock video request from VISP network 180, it checks the Number of Copies Rented field in the video's header. If the Number of Copies Rented is equal to the Number of Copies Owned field, then VPOP network 150 sends a Lock Video Request deny message back to VISP network 180. Otherwise, VPOP network 150 checks whether the Lock Video Request is a rental or purchase transaction. If it is a purchase transaction, VPOP network 150 decrements the Number of Copies Owned field, sets the Download Status field in that copy's header to “Purchase Download Pending” and sends a Lock Video Acknowledge message to VISP network 180. If the Lock Video Request from VISP network 180 is a rental transaction, VPOP network 150 increments the Number of Copies Rented field in the video's header, sets the Download Status field in that copy's header to “Rental Download Pending” and sends a Lock Acknowledge message to VISP network 180. In both rental and purchase transactions, VPOP network 150 updates the NVP ID field in that video copy's header with the NVP ID of NVP 112 requesting the transaction.

When VPOP network-150 receives a download or extension request from NVP 112, VPOP network 150 looks through the array of headers for the video requested to see if the NVP ID exists. If the NVP ID does not exist, VPOP network 150 sends an error message back to NVP 112. If the NVP ID exists and it is an extension request, VPOP network 150 sends a Download Complete message to VISP network 180 (along with NVP ID and VIDEO URL information) and sends a duration extended message to NVP 112. If the NVP ID exists and it is a download request, VPOP network 150 creates a new header for the video to be downloaded to NVP 112. VPOP network 150 fills in the VPOP URL, the VIDEO URL, the Compression Type value, the Owned/Rented value (based on whether the Download Status indicates purchase or rental pending), the Header Checksum value, and the Video Checksum value. The header is downloaded to NVP 112 first, followed by the actual video file.

If the download is successful, VPOP network 150 sends a Download Complete message to VISP network 180, providing the NVP ID, the VPOP URL, and the VIDEO URL. If the download is unsuccessful, VPOP network 150 checks the Download Status field in that video copy's header to see if the video was a rental or a purchase. If the video was a rental, VPOP network 150 decrements the Number of Copies Rented field in the video header. If it was a purchase transaction, VPOP network 150 increments the Number of Copies Owned field in the video header (the above two steps restore the original number of copies owned or rented and cancel out the pending transaction). VPOP network 150 also clears the NVP ID and Download Status fields from that video copy's header. Finally, VPOP network 150 sends a Download Failed message to VISP network 180 and provides the NVP ID and the VIDEO URL.

As introduced hereinabove, those skilled in the art will readily see that the video or other data content may suitably be downloaded in a variety of ways. According to one advantageous embodiment, for the purposes of downloading, the video file may be divided into a plurality of associated data segments. Each data segment is self contained and may be downloaded independently of the others and then used to reconstruct the video content at subscriber site 110. Advantageously, the data segments are sequenced numerically using file name extensions. Segmenting or otherwise breaking up the video files allows NVP 112 to start playing the movie after the first segment is downloaded. The other data segments continue to download while the first segment (and subsequent segments thereafter) continue to play. According to a related advantageous embodiment, individual segment size may be determined based on the slowest download speed to ensure that the next segment will be downloaded before the previous segment finishes playing on NVP 112.

According to yet another related embodiment, the download process may be interrupted because of a failure of VPOP network 150, thereby enabling NVP 112 to choose to continue downloading the segment content from another VPOP network 150 starting from the segment that was interrupted rather than starting the entire download process over again. This enables the subscriber to recover from errors without incurring the prolonged delay that would occur if the video file download were restarted from the beginning.

Besides browsing VISP network 180 web site and requesting video content to be rented or purchased, the subscriber can also select and view videos already downloaded to NVP 112. To select a locally stored video, the subscriber chooses the select option on the remote control or wireless keyboard. At this point, a list of all locally stored videos is displayed on the subscriber's television screen. The subscriber navigates through the list of videos and chooses a video to be viewed. Once a video is selected, the subscriber can apply typical VCR commands like play, fast forward, rewind, pause and stop. The rewind, fast forward, pause and stop commands are completely local (do not require any transactions with VPOP network 150 or VISP network 180). When one of these commands is chosen, NVP 112 performs the appropriate action on the locally stored video.

When the subscriber elects to play locally stored video that the subscriber has selected, NVP 112 checks the Owned/Rented field in the video's header to determine if the video is owned by the subscriber or rented. If the video is owned, then it is played on the subscriber's TV screen. If the video is rented, NVP 112 checks the Time Last Checked value in the video's header to determine the last time the video was played. If the Time Last Checked is within two hours of the current NVP time, then the video is immediately played on the subscriber's TV screen. If the time elapsed since the Time Last Checked value is greater than two hours, then NVP 112 uses the VPOP URL value in the video header to connect to VPOP network 150 from which the video is rented. NVP 112 also provides VPOP network 150 with the NVP ID of NVP 112, as well as the VIDEO URL value stored in the video's header.

NVP 112 waits for VPOP network 150 to determine whether the video is within the video rental duration. If the video is still within the rented duration, NVP 112 updates the Time Last Checked value to the current time and plays the video on the subscriber's TV screen. If the video's rental duration has expired NVP 112 prompts the subscriber to extend the video's rental duration. If the subscriber does not elect to extend the rental duration, NVP 112 deletes the video from local storage. If the subscriber elects to extend the rental duration, NVP 112 connects to VISP network 180 and provides it with the VPOP URL for VPOP network 150, the VIDEO URL, and the NVP ID information. VISP network 180 then displays the user authentication screen on the subscriber's TV screen. The subscriber follows the authentication and payment processes described previously. When authentication is done, NVP 112 connects to VPOP network 150 and provides it with the VIDEO URL and NVP ID and requests to extend the video rental. After extension confirmation is received from VPOP network 150, NVP 112 updates the Time Last Checked value to the current time and plays the video on television 111.

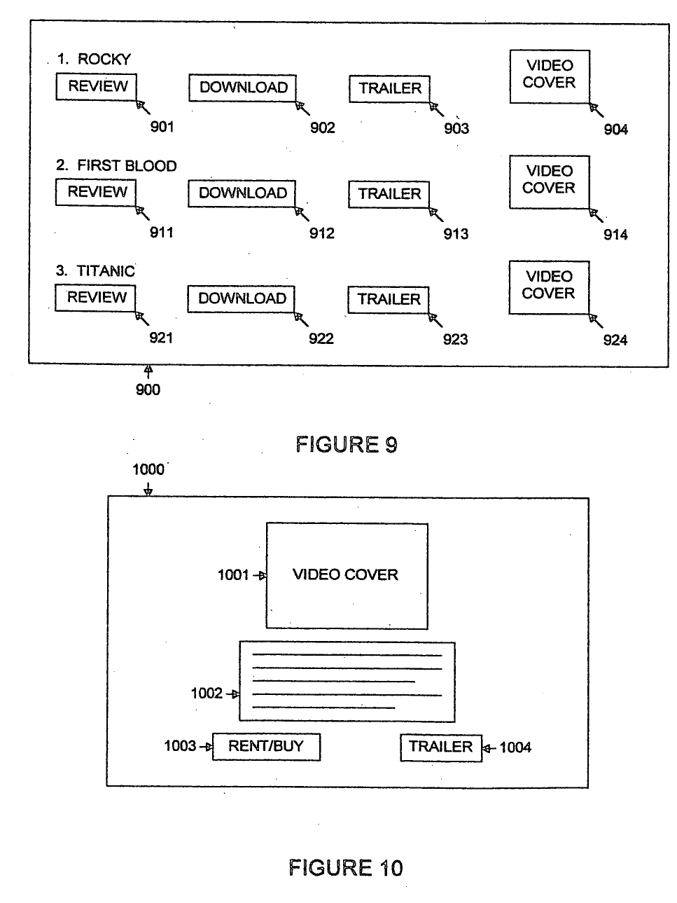

FIG. 9 illustrates exemplary web page 900 from which a subscriber using NVP 112 may select a video to rent or to purchase, according to one embodiment of the present invention. Web page 900 contains listings for three videos, “Rocky,” “First Blood,” and “Titanic,” which the subscriber may rent using NVP 112. Four selectable icons are associated with the “Rocky” video, including review icon 901, download icon 902, trailer icon 903, and video cover icon 904. Similarly, four selectable icons are associated with the “First Blood” video, including review icon 911, download icon 912, trailer icon 913, and video cover icon 914. Finally, four selectable icons are associated with the “Titanic” video, including review icon 921, download icon 922, trailer icon 923, and video cover icon 924. Selecting any one of the review icons transfers the subscriber to web page 1000, explained below in FIG. 10, from which the subscriber may read a review of the corresponding movie. By selecting any one of the download icons, the subscriber may begin the process of downloading the selected video to NVP 112. By selecting any one of the trailer icons, the subscriber may view a brief video clip from the corresponding video file. Selecting any one of the video cover icons transfers the subscriber to web page 1000. In an advantageous embodiment of the present invention, video cover icons 904, 914, and 924 are smaller sized graphic images (typically in JPEG or GIF format) of the box cover of the corresponding video.

FIG. 10 illustrates exemplary web page 1000 from which a subscriber using NVP 112 may learn additional details concerning a selected video, according to one embodiment of the present invention. The subscriber using NVP 112 enters web page 1000 by selecting, for example, one of video cover buttons 904, 914, or 924 in web page 900. Web page 1000 comprises video cover icon 1001, movie review text 1002, selectable rent/buy icon 1003, and selectable trailer icon 1004.

Movie review text 1002 comprises a scrollable window containing text reviews and/or a synopsis of the corresponding video. Selecting trailer icon 1004 allows a subscriber to view a brief video clip from the corresponding video file. Selecting rent/buy icon 1003 leads to subsequent web pages that begin the process of downloading the selected video to NVP 112. In an advantageous embodiment of the present invention, video cover icon 1001 is a larger sized graphic image (typically in JPEG or GIF format) of the box cover of the corresponding video.

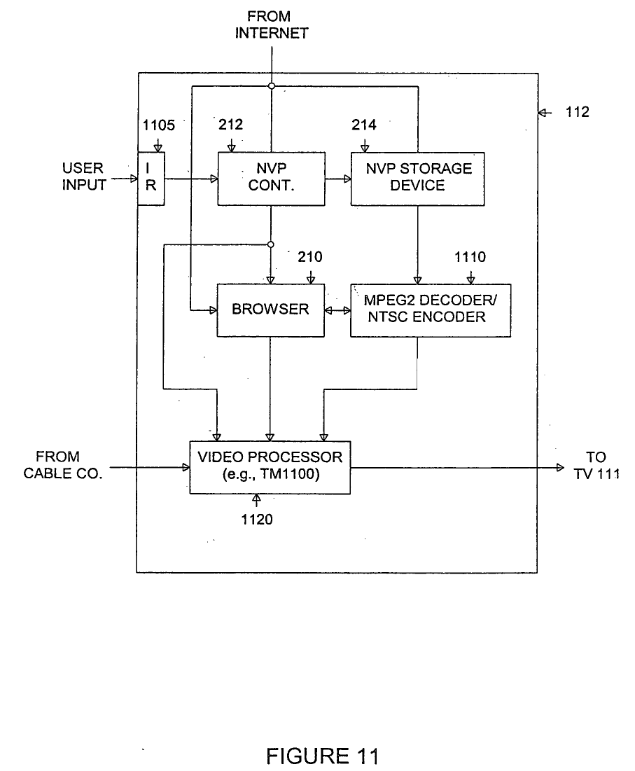

FIG. 11 is a more detailed block diagram of selected portions of exemplary network video player 112 according to one embodiment of the present invention. Network video player (NVP) 112 comprises IR sensor 1105, NVP controller 212, browser 210, NVP storage device 214, MPEG2 decoder/NTSC encoder 1110, and video processor 1120. In the embodiment shown, NVP 112 is implemented as a set-top box that receives television signals from a cable service provider for display of television set 111. However, unlike a conventional cable box, NVP 112 is also capable of browsing the Internet and downloading and renting a video file or other data file. Advantageously, NVP 112 may access the Internet via the cable connection, such as by using a high-speed cable modem service. Alternatively, NVP 112 may use a separate connection, such as a digital subscriber line (DSL), to access the Internet. In other embodiments of the present invention, NVP 112 may receive external television signals from an antenna, rather than from a cable service provider.

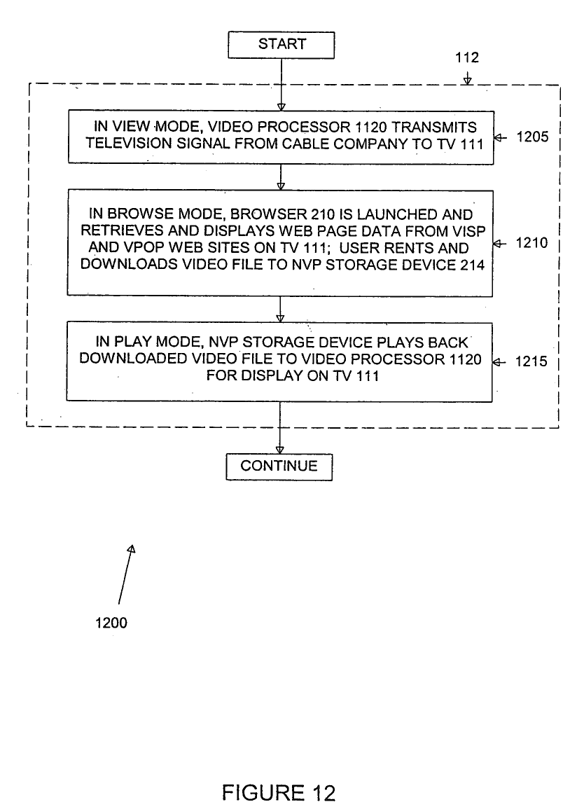

FIG. 12 depicts flow chart 1200, which illustrates the operation of the exemplary network video player 112 according to one embodiment of the present invention. NVP controller 212 directs the overall operation of network video player 112, including View mode, Play mode and Browse mode. In View mode, NVP controller 212 causes the incoming television signal from the cable service provider to be demodulated and processed by video processor 1120 and transmitted to television set 111, without storing or retrieving from NVP storage device 214 (process step 1205). Video processor 1120, which may be, for example, a TriMedia™ 1100 media processor, contains radio frequency (RF) front-end circuitry for receiving incoming television signals from the cable service provider, tuning to a user-selected channel, and converting the selected RF signal to a baseband television signal (e.g., super video signal) suitable for display on television set ill. Video processor 1120 also is capable of receiving a conventional NTSC signal from MPEG2 decoder/NTSC encoder 1110 during Play mode and transmitting baseband television signal (e.g., super video signal) to television set 111.

In Browse mode, NVP controller 212 launches browser 210 and directs video processor 1120 to receive its input video signal from browser 210. Once launched, browser 210 receives user commands from, for example, a remote control or an infrared-capable wireless keyboard or mouse. Browser 210 accesses web pages from VISP network 180 and VPOP networks 150, 160, and 170, as explained above, and causes video processor 1120 to display the web pages on television set 111. Video previews, such as MPEG2 video files, received by browser 210 may be transferred to MPEG2 decoder/NTSC encoder 1110 for display in a window on television set 111. Eventually, the user may rent and download a video or other data file. The downloaded video file is stored in NVP storage device 214 for subsequent playback on television set 111 (process step 1210). In Play mode, NVP controller 212 directs NVP storage device 214 to stream a downloaded, rented video file to MPEG2 decoder/NTSC encoder 1110, which converts the MPEG2 data from NVP storage device 214 to, for example, a super video (S-Video) signal that video processor 1120 transmits to television set 111 (process step 1215).

The MPEG2 standard was chosen for MPEG2 encoder 220 and MPEG2 decoder/NTSC encoder 1110 only for the purposes of explaining the invention. In alternate embodiments of the present invention, the MPEG encoder and decoder may comply with the MPEG-1, MPEG-2, MPEG-4 or MPEG-7 standards.

For the purposes of this application and the claims that follow, NVP storage device 214 is defined to include any mass storage device that is both readable and writable, including conventional magnetic disk drives, magnetic tapes for a video cassette recorder (VCR) or video tape recorder (VTR), and optical disk drives for read/write digital versatile disks (DVD-RW), re-writable CD-ROMS, and the like. In fact, NVP storage device 214 need not be fixed in the conventional sense that is permanently embedded in network video player 112. Rather, NVP storage device 214 includes any mass storage device that is dedicated to network video player 112 for the purpose of storing recorded video programs. Thus, NVP storage device 214 may include an attached peripheral drive or removable disk drives (whether embedded or attached), such as a juke box device that holds read/write DVDs or re-writable CD-ROMs. Furthermore, in an advantageous embodiment of the present invention, NVP storage device 214 may include external mass storage devices that network video player 112 may access and control via a network connection (e.g., Internet protocol (IP) connection), including, for example, a disk drive in the user's home personal computer (PC) or a disk drive on a server at the user's Internet service provider (ISP).

Although the present invention has been described in detail, those skilled in the art should understand that they can make various changes, substitutions and alterations herein without departing from the spirit and scope of the invention in its broadest form.

1. For use in a communication network capable of communicating with a plurality of video content servers capable of providing a plurality of video files for download to a subscriber, a subscriber video player comprising:
a storage medium capable of storing selected ones of said plurality of video files downloaded from said plurality of video content servers;
a first controller capable of receiving inputs from a first subscriber using said subscriber video player; and
a browser application coupled to said first controller and responsive to said inputs from said first subscriber, said browser application capable of accessing said video content servers and retrieving therefrom web page data associated with said plurality of video files and displaying said web page data on a display screen coupled to said subscriber video player.

2. The subscriber video player as set forth in claim 1 wherein said browser application, in response to a first input from said first subscriber requesting a first selected one of said plurality of video files, retrieves said first selected video file from a first one of said plurality of video content servers and stores said retrieved first selected video file on said storage medium.

3. The subscriber video player as set forth in claim 2 wherein said browser application is capable of displaying on said display screen a plurality of video selection menus associated with said web page data, a first one of said video selection menus containing a first menu option associated with said first selected video file, wherein said browser application is further capable of receiving from said first subscriber a first video selection message selecting said first selected video file for downloading to said subscriber video player.

4. The subscriber video player as set forth in claim 3 wherein said browser application, in response to receipt of said first video selection message, transmits to said first video content server a video request message comprising a subscriber identifier associated with said subscriber video player, said video request message capable of causing said first video content server to transmit said first selected video file to said subscriber video player when said subscriber video player subsequently transmits said subscriber identifier to said first video content server.

5. The subscriber video player as set forth in claim 4 wherein said video request message further comprises a video identifier associated with said first selected video file, wherein said first video content server uses said video identifier to select said first selected video file from said plurality of video files for transmission to said subscriber video player.

6. The subscriber video player as set forth in claim 2 further comprising a video processor coupled to said browser application and capable of receiving said web page data from said browser application and displaying said web page data on said display screen.

7. The subscriber video player as set forth in claim 6 wherein said first video processor is further capable of receiving an incoming television signal from an external source and displaying said incoming television signal on said display screen.

8. The subscriber video player as set forth in claim 7 wherein said external source is one of an antenna and a cable television system.

9. A communication network comprising:
a plurality of video content servers capable of providing a plurality of video files for download to subscribers; and
a plurality of subscriber video players capable of receiving downloading selected ones of said plurality of video files, each of said plurality of subscriber video players comprising:
a storage medium capable of storing selected ones of said plurality of video files downloaded from said plurality of video content servers;
a first controller capable of receiving inputs from a subscriber using said each subscriber video player; and
a browser application coupled to said first controller and responsive to said inputs from said subscriber, said browser application capable of accessing said video content servers and retrieving therefrom web page data associated with said plurality of video files and displaying said web page data on a display screen coupled to said each subscriber video player.

10. The communication network as set forth in claim 9 wherein said browser application, in response to a first input from said subscriber requesting a first selected one of said plurality of video files, retrieves said first selected video file from a first one of said plurality of video content servers and stores said retrieved first selected video file on said storage medium.

11. The communication network as set forth in claim 10 wherein said browser application is capable of displaying on said display screen a plurality of video selection menus associated with said web page data, a first one of said video selection menus containing a first menu option associated with said first selected video file, wherein said browser application is further capable of receiving from said subscriber a first video selection message selecting said first selected video file for downloading to said each subscriber video player.

12. The communication network as set forth in claim 11 wherein said browser application, in response to receipt of said first video selection message, transmits to said first video content server a video request message comprising a subscriber identifier associated with said each subscriber video player, said video request message capable of causing said first video content server to transmit said first selected video file to said each subscriber video player when said each subscriber video player subsequently transmits said subscriber identifier to said first video content server.

13. The communication network as set forth in claim 12 wherein said video request message further comprises a video identifier associated with said first selected video file, wherein said first video content server uses said video identifier to select said first selected video file from said plurality of video files for transmission to said each subscriber video player.

14. The communication network as set forth in claim 10 further comprising a video processor coupled to said browser application and capable of receiving said web page data from said browser application and displaying said web page data on said display screen.

15. The communication network as set forth in claim 14 wherein said first video processor is further capable of receiving an incoming television signal from an external source and displaying said incoming television signal on said display screen.

16. The communication network as set forth in claim 15 wherein said external source is one of an antenna and a cable television system.

17. For use in subscriber video player, a method of accessing a plurality of video files on a plurality of video content servers via a communication network, the method comprising the steps of:
receiving inputs from a first subscriber using the subscriber video player; and
in response to the inputs from the first subscriber, browsing the plurality of video content server in the communication network;
retrieving web page data associated with the plurality of video files and displaying the web page data on a display screen coupled to the subscriber video player;
storing selected ones of the plurality of video files downloaded from the plurality of video content servers on a storage medium associated with the subscriber video player.

18. The method as set forth in claim 17 further comprising, in response to a first input from the first subscriber requesting a first selected one of the plurality of video files, the steps of retrieving the first selected video file from a first one of the plurality of video content servers and storing the retrieved first selected video file on the storage medium.

19. The method as set forth in claim 18 further comprising the steps of displaying on the display screen a plurality of video selection menus associated with the web page data, a first one of the video selection menus containing a first menu option associated with the first selected video file; and
receiving from the first subscriber a first video selection message selecting the first selected video file for downloading to the subscriber video player.

20. The method as set forth in claim 19 further comprising, in response to receipt of the first video selection message, the steps of transmitting to the first video content server a video request message comprising a subscriber identifier associated with the subscriber video player, the video request message capable of causing the first video content server to transmit the first selected video file to the subscriber video player when the subscriber video player subsequently transmits the subscriber identifier to the first video content server.

21. The method as set forth in claim 20 wherein the video request message further comprises a video identifier associated with the first selected video file, wherein the first video content server uses the video identifier to select the first selected video file from the plurality of video files for transmission to the subscriber video player.
